(19) United States
(12) Patent Application Publication
(10) Pub. No.: US 2022/0046859 A1
(43) Pub. Date: Feb. 17, 2022

(54) SYSTEM AND METHOD FOR SELECTIVE HARVESTING AT NIGHT OR UNDER POOR VISIBILITY CONDITIONS, NIGHT DILUTION AND AGRICULTURE DATA COLLECTION

(71) Applicant: TEVEL AEROBOTICS TECHNOLOGIES LTD., Modiin (IL)

(72) Inventors: Yaniv MAOR, Modiin (IL); Arkadi TAFLIA, Mazkeret Batya (IL); Gregory KHODOS, Rishon Le-Zion (IL); Nir HERMONI, Kiryat Ono (IL); Doron FINE, Rishon Le-Zion (IL); Vered POZNIAK, Holon (IL)

(21) Appl. No.: 17/312,556

(22) PCT Filed: Dec. 9, 2019
(86) PCT No.: PCT/IL2019/051338

§ 371 Date: Jun. 10, 2021

Related U.S. Application Data
(60) Provisional application No. 62/777,956, filed on Dec. 11, 2018.

(51) Int. Cl. A01D 46/253; B64C 39/02; G05B 13/02

(52) U.S. Cl. CPC A01D 46/253; B64C 39/024; G06Q 10/0637; B64C 2201/127; G05B 13/028

(57) ABSTRACT

The present invention provides systems and methods for harvesting and diluting crops during night time or under low illumination conditions using ground- or aerial-robot/unmanned aircraft vehicle (UAV).

### FIELD OF THE INVENTION

The present invention is in the technical field of agriculture technology, specifically night harvesting, night thinning, fog harvesting, fog thinning, and low illumination harvesting as cloudy day. More particularly, the present invention relates to night harvesting-, dilution- and pruning-devices, systems and methods. More particularly, the present invention relates to night harvesting-, dilution- or pruning-devices for orchards, plantations green houses and field, such as apple-, pear-, apricot-, peach-, orange-, small-citrus fruit-, and lemon-trees, avocado, vines, tomatoes, eggplants, cucumbers, and peppers.

### BACKGROUND

Conventional orchards harvesting is a selective task, based on mass labor work and on human understanding and training for detection of fruit quality. Advanced harvesting tools are based on ground and aerial robots' platforms, like large-tracks and drones, all having robotic arms. These platforms are usually equipped with GPS, a LIDAR-based camera or a 3D-camera for detection of fruit and for classification of its quality and/or ripeness for performing selective harvesting.

Today, in mechanic harvesting, there is no selection between ripe and un-ripe fruit. However, selective harvesting is advantageous since the ripeness process is long, i.e. a period of several weeks, and not uniform with all trees in a plantation or even at the same tree. In addition, it is desirable to prevent damage to both the trees and the fruits. Nevertheless, selective harvesting and selective thinning require mass labor for a short period, which lays an economic burden on farmers that often choose not to follow up the plantation status and not to manage a database for plantation, but rather harvest all the fruits at once.

Moreover, farmers don't have the tools to perform real selective harvesting/dilution mainly due to shortage in manpower and due to the short harvesting period. Moreover, short platforms and ground platforms cannot collect effectively data of a fruit from few directions and during the movement of a harvesting arm.

Dilution (or thinning) is usually done manually by mass labor work, by disconnecting fruits in their early stage from the tree, to thereby enable the growth of fewer, but larger fruits. Pruning is usually done with a manual saw or by a ground vehicle holding a saw.

Contrary to the present invention, ground and aerial robots are designed to work only during the daylight since their sensors, which are camera-based, require sunlight to enable them to determine fruit quality parameters, such as fruit diameter and color.

Moreover, existing ground and aerial harvesting robots are not designed to perform data collection about fruit quality and storage same for later use, and usually the harvesting is done at the same time of the data collection.

The present invention thus provides systems and method for collection of data and use thereof for nighttime harvesting, dilution and pruning.

### BRIEF DESCRIPTION OF THE DRAWINGS

FIG. 1A is an exemplary database top view of an orchard.

FIG. 1B illustrates data collection of an orchard during daytime, while identifying fruits' position and quality.

FIG. 1C illustrates the generation of a harvesting plan according to the method of the invention.

FIG. 1D illustrates nighttime-harvesting executed according to the harvesting plan.

### DETAILED DESCRIPTION

Today, harvesting is done mainly during the daytime due to poor visual capabilities (of either manual labor or robotics) and/or insufficient lighting abilities. This means that harvesting, which is already limited to a short period in which the fruits are ready for picking, is further reduced by about 50%. The present invention aims at solving this problem by providing systems and methods for nighttime harvesting and dilution missions.

Accordingly, the present invention provides a system and method for robotic harvesting during the night, fog, twilight, i.e. performing harvesting, thinning and/or pruning of an orchard.

In certain embodiments, the methods of the invention comprise the steps of: (a) detecting and classification of fruits in the daylight; (b) detecting leafage in the daylight; (c) generating maneuvering trajectory (optionally in the daytime); (d) determining fruit inertial localization by integrating data from a GPS and a 3D-camera; (e) saving fruit position and grade in a database; (f) optionally, time integration of fruit grade; and (g) sending at nighttime agents/robots/drones to harvest the fruit according to the information saved in the database.

In certain embodiment, the step of collecting fruits' data in the method of the invention, is carried out at night by using suitable controlled illumination, and the harvesting step is carried out during daytime, to thereby remove/eliminate the effect of non-controlled-stable illumination by sunlight. According to this embodiment, the present invention provides a method comprising the steps of: (a) detecting and classification of fruits during nighttime; (b) determining fruit inertial localization by integrating data from a GPS and a 3D-camera; (c) saving fruit position and grade in a database; (d) optionally, time integration of fruit grade and (e) sending at daytime agents/robots/drones to harvest the fruit according to the information saved in the database, which collected at night.

Accordingly, the present invention provides a method for harvesting or pruning fruits, the method comprising the steps of: (i) gathering data regarding trees' location and fruits' location and quality; (ii) determining a harvesting plan according to the gathered data; and (iii) instructing harvesting robots/UAVs to harvest fruits according to the determined harvesting plan. In specific embodiments, the gathering of the data in step (i) is carried out during daytime, and the harvesting/pruning is carried out during nighttime or under poor visibility conditions that prevent regular optic use. In alternative specific embodiments, the gathering of the data in step (i) is carried out during nighttime by using artificial illumination or special night vision equipment, and the harvesting/pruning is carried out during daytime to thereby eliminate the effect of direct sun-blur on regular optics.

The present invention further provides harvesting devices for, e.g., orchards and vines, as well as harvesting methods using robots/drones/unmanned aircraft vehicle (UAV).

In certain embodiments, the harvesting robot/drone of the invention is equipped with a harvesting arm designed to pick a fruit. In specific embodiments, the harvesting arm is further equipped with cutting means, such as saw, knife, clippers, or secateurs, for cutting a desired fruit from a tree.

The present invention further provides a thinning device that have a similar harvesting arm as the harvesting device for disconnecting small fruits from the tree. The present invention also provides a pruning device having an arm similar to the harvesting arm of the harvesting device, wherein the pruning arm is designed to apply greater force in order to disconnect branches from the trees.

In certain embodiments, the harvesting robot/drone of the invention is further equipped with an anti-collision system, designed to prevent unintentional collision with obstacles, such as trees, people and other robots/drones, and to enable safe navigation in a complex environment. The anti-collision system includes, but is not limited to: IR range opto-coupler, ultrasonic range measurement, stereoscopic camera, RADAR and vision camera, which can work at both daytime and at night.

In certain embodiments, the harvesting robot/drone of the invention further comprises a fruit detection unit, such as a camera, that is designed to measure the size, color and shape of a fruit, and optionally also a device that have a tactile feedback about the fruit's rigidness/softness.

The present invention further provides an algorithm that based on a fruit's position, navigates the drone to an optimal harvesting position. The present invention further provides an algorithm that, based on data obtained from a fruit detection unit and/or tactile feedback, decides whether a fruit is ripe and ready to be plucked. In specific embodiments, one or both algorithms are based on the database generated by the robots/drones/UAVs and their sensors when gathering data during daytime.

The present invention further provides an algorithm that detects the fruit position, navigates the drone to an optimal position, and an algorithm that decides if the fruit is ripe and ready to be plucked.

Accordingly, the present invention provides a fruit harvesting device/UAV comprising: (a) a small unmanned aircraft vehicle (UAV), such as drones/mini-copter/quad-copter, equipped with: (i) a harvesting unit; (ii) a power source; (iii) an anti-collision system; (iv) a fruit detection unit; and (v) a protruding and pushing cage, and (b) a computer comprising a memory, a processor, and an algorithm that calculates the fruit's position in relation to the UAV, wherein: (1) said anti-collision system prevents collision of said UAV with obstacles (such as trees, people, and other UAVs) thus enabling autonomous navigation of said UAV in a complex environment; (2) said fruit detection unit together with said computer and algorithm enables autonomous maneuvering said UAV and/or said harvesting unit to the fruit; and (3) said cage allows airflow and assists in the harvesting process by both (a) pushing branches and leaves aside for enabling the UAV to penetrate into the treetop/leafage, and (b) providing a counter push when pulling said fruit off the tree, and further protects said UAV and its engine blades from potential hazard (such as leaves and branches).

The present invention further relates to a mapping device, system and method for mapping plantations and fruits therein. The system and method are based on robots/drones/mini-copters/quad-copters, or any other small UAVs, and on the method of the invention for building a database containing the position of every fruit in the plantation, and optionally the fruit's ripeness.

The present invention further provides a computerized system for mapping an orchard, namely positioning of every tree contour in the orchard and every fruit on each tree, the computerized system comprises: (a) one or more anchor units comprising a marker; (b) a ground or flying unit equipped with a camera for taking a plurality of photographs of a predetermined zone; and (c) a mapping unit comprising a processor and memory for receiving said plurality of photographs and: (i) visually identifying one or more markers of anchor units in said photographs and their geographic location; and (ii) mapping trees identified in said photographs in relation to the location of identified one or more anchor units; wherein one or more anchor units are positioned at a specific target point within said predetermined zone. In specific embodiments, each of said one or more anchor units further comprises a positioning unit.

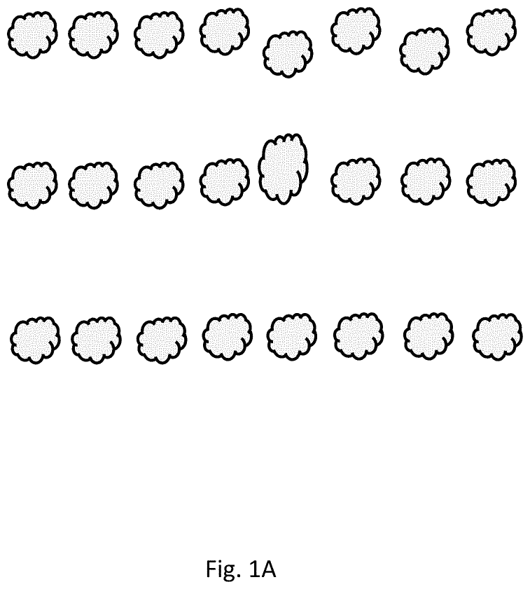

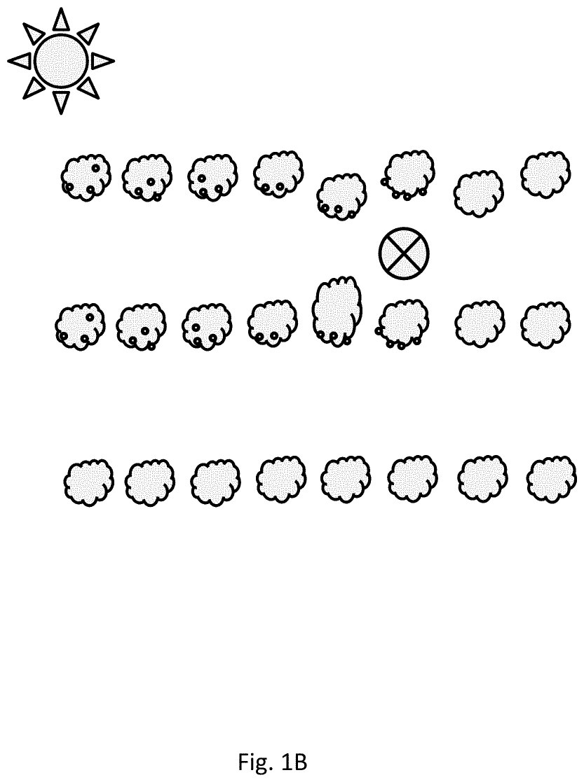

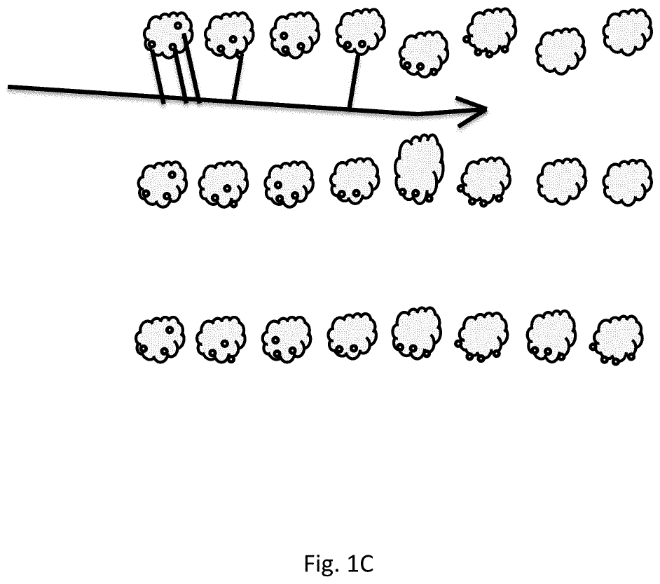

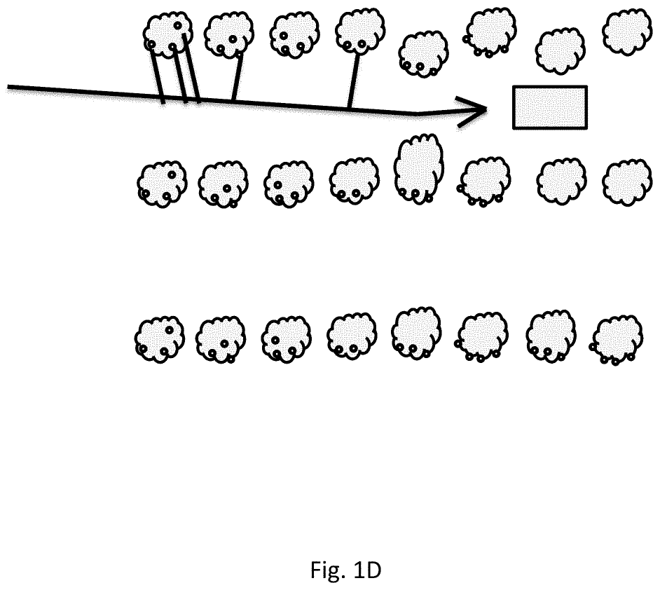

FIG. 1A illustrates an orchard that needs to be mapped for harvest. FIG. 1B illustrates how a UAV flies over the orchard during daytime (or at night by using suitable lightning) maps the trees in the orchard while identifying fruits' location on each tree as well as fruits' quality and ripeness. The data gathered regarding trees' location and fruits' location and quality is analyzed by a computer to generate harvesting (or pruning) plan (FIG. 1C), to be executed by harvesting robots/UAVs at a later time, e.g. during nighttime (FIG. 1D).

In certain embodiments, the system of the invention further comprises an anchor-carrying (small) unmanned aircraft vehicle (UAV) that can carry each anchor unit to different target positions in the orchard, wherein each anchor unit is positioned at a specific target point by said anchor-carrying UAV and transmits data to said mapping unit/computer. The target unit can be connected to the UAV with a snap, controlled magnet, and may be released when the UAV is on the ground.

In certain embodiments of the mapping system of the invention, the positioning unit is selected from: a GPS receiver; a LPS transceiver; an ultra-wide-band transceiver; and a visual positioning system, or any combination thereof.

In certain embodiments of the mapping system of the invention, the anchor unit and/or said anchor-carrying UAV further comprise a wireless communication unit for transmitting data to said mapping unit.

In specific embodiments of the mapping system of the invention, the anchor unit and said anchor-carrying UAV constitute a single unit.

In certain embodiment, each anchor unit in the mapping system of the invention can move or be moved from one target point to another, thus serving as multiple anchoring units during said scan/identification by said satellite, a high-flight aircraft and/or a UAV.

In certain embodiments of the mapping system of the invention, the location/position of each anchor unit is scanned/identified by satellite or high-flight aircraft (such as a UAV) that identify said markers/optical targets of each of said anchor units, which then transmits said position-data to said mapping unit.

In certain embodiments, the mapping system of the invention further comprises a scanning UAV that fly over the orchard and scan/identify said marker/optical targets of said anchor unit(s). In specific embodiments, the scanning-drone(s) according to the invention may be a drone with a camera, which includes GPS receiver and a camera pointed vertically to the ground. In a specific embodiment, the system of the invention further comprises one or more scanning UAVs that fly over the orchard and scan/identify said markers of said anchor units.

In certain embodiments of the mapping system of the invention, the algorithm used therewith comprises at least one of: (a) autonomous navigation and landing algorithm for the carrier UAV (for optimal positioning of the anchor unit and preventing landing onto a tree); (b) fixed position GPS accuracy averaging algorithm for the anchoring unit (for increasing the accuracy of the location of each anchor unit after positioning); (c) stitching-algorithm for generating a super-resolution image from multiple images obtained from different sources and/or positions; (d) best-fit algorithm for providing GPS positioning for each pixel within said super-resolution image; (e) an algorithm for detecting trees position, trees contour, and tree-lines position; and (f) a database-building algorithm of harvesting- and fruit-status in the orchard.

In certain embodiments of the mapping system of the invention, said mapping unit is designed to: (i) generate a super-resolution image from multiple images obtained from different sources and/or positions using a stitching-algorithm; (b) provide GPS positioning for each pixel within said super-resolution image; (c) detect trees position, trees contour, and tree-lines position; and (f) build a database of harvesting- and fruit-status in the orchard.

The present invention further provides a computerized system and method for building a database that is based on a supper-resolution image. The database according to the invention is designed to include/hold calculations of position (coordinate-global or local) of every pixel in the supper-resolution image, include/hold fruit position-map and include/hold fruit quality information. The final database is then designed to be used for continuous and periodic collection of various harvesting information, including fruit position and quality as seen in daylight.

The present invention further provides a robot management-software designed to analyze all the data that is collected during the daytime, and use the data to generate a harvesting plan for, e.g., ground and aerial robots to harvest the fruit during nighttime.

The present invention further provides a system and method for management of a fleet of harvester/thinning robots/drones. Accordingly, in specific embodiments, the present invention provides a fleet management system for managing and operating a fleet of harvester/thinning robots/drones during the nighttime based on a database generated according to data obtained/gathered during the daytime. In specific embodiments, the database of the harvesting fleet management system of the invention further comprises accumulated data about fruit position and quality as collected in daylight by other robot(s) or drone(s).

The present invention provides a management system for autonomous unmanned aircraft vehicle (UAV) fleet management for harvesting or diluting fruits, said system comprises: (a) one or more autonomous UAVs for harvesting fruit or dilution fruit, comprising: (i) a computing system comprising a memory, a processor; (ii) a fruit harvesting unit; (iii) a power source; (iv) an anti-collision system; (v) a fruit detection unit adapted for calculating a fruit's position in relation to the UAV; and (vi) a protruding, netted cage adapted for pushing branches and leaves; wherein: said anti-collision system prevents collision of said UAV with obstacles thus enabling autonomous navigation, flight and maneuvering of said UAV towards a predetermined target location; said UAV uses fruit position information received from the fruit detection unit in order to maneuver said UAV and position the harvesting unit in a place where it can harvest the identified fruit; said cage is adapted to assist the harvesting process by pushing branches and leaves aside to enable the UAV to penetrate into the treetop/leafage and reach fruit inside. and/or (b) providing a counter push when pulling said fruit off a branch by the harvesting unit while the cage; (b) a computerized system for mapping an orchard or a database of trees' position and their contour; (c) a base station; (d) optionally, a fruit container; and (e) one or more energy suppliers, wherein said management system is used for: (1) managing fleet of UAVs including: fruit harvesting UAV's, fruit containers, fruit carrier UAV's, anchor units, and anchor-carrying UAV's; and/or (2) harvesting or dilution missions based on fruit's ripeness.

Accordingly, in certain embodiments, the present invention provides a computerized system and method for optimal harvesting using a UAV fleet using a processor and memory, the method comprising the steps of: (a) providing a fleet management system of the invention; (b) gathering data about an orchard during the daytime and using same for building a database of an orchard comprising multi-layer representation of the orchard and fruit's information; (c) generating and providing tasks to autonomous fruit harvesting UAVs for harvesting the fruits during the nighttime. In specific embodiments, the directing of the fruit harvesting UAVs to fruits is based according to quality and ripeness (based on the generated database) and not in a sequential linear manner (as done today).

In certain embodiments of the method for optimal harvesting according to the invention, the fruit harvesting UAVs further collect and provide updated fruit's information for updating the database.

In certain embodiments, the present invention provides a computerized method for optimal harvesting using a UAV fleet using a processor and memory, said method comprising the steps of: (a) building a digital representation of an orchard in a database of an orchard, wherein said database comprises a multi-layer representation of the orchard and fruits' information; (b) providing tasks to autonomous fruit harvesting UAVs that both harvest fruits and provide updated fruit's information for updating said database; (c) updating said database during harvesting via data obtained from different UAVs in the orchard during harvest; and (d) directing said fruit harvesting UAVs to fruits that need to be harvested based on the generated database.

The present invention provides a fruit harvesting, dilution and/or pruning system comprising: (a) a computerized system for mapping an orchard or a map of trees position and their contour in a plantation; (b) a management system for autonomous unmanned aircraft vehicle (UAV) fleet management for harvesting, diluting or pruning fruits, said system comprises: (i) one or more improved autonomous UAVs for harvesting fruit or dilution fruit, comprising: a computing system comprising a memory, a processor; a fruit harvesting unit; a power source; an anti-collision system; a fruit detection unit adapted for calculating a fruit's position in relation to the UAV; and a protruding, netted cage adapted for pushing branches and leaves; wherein: said anti-collision system prevents collision of said UAV with obstacles thus enabling autonomous navigation, flight and maneuvering of said UAV towards a predetermined target location; said UAV uses fruit position information received from the fruit detection unit in order to maneuver said UAV and position the harvesting unit in a place where it can harvest the identified fruit; said cage is adapted to assist the harvesting process by pushing branches and leaves aside to enable the UAV to penetrate into the treetop/leafage and reach fruit inside, and/or providing a counter push when pulling said fruit off a branch by the harvesting unit while the cage, (ii) a base station; (iii) optionally, a fruit container; and (iv) one or more energy suppliers, wherein said management system is used for: (1) managing fleet of UAVs including: fruit harvesting UAV's, fruit containers, fruit carrier UAV's, anchor units, and anchor-carrying UAV's; and/or (2) harvesting or dilution missions based on fruit's ripeness.

1. A system for nighttime fruit harvesting, dilution and/or pruning, the system comprising:
a) at least one flying/ground unit equipped with a camera for taking a plurality of photographs of a predetermined zone during daytime and for collecting fruits' data at daylight, e.g. fruit quality and position;
b) a computerized system for mapping an orchard, comprising a processor and memory for receiving said plurality of photographs, wherein said computerized system is designed to (i) visually identify one or more markers of anchor units in said photographs and their geographic location; (ii) map trees identified in said photographs in relation to the location of identified one or more anchor units; and (iii) generate a database of: trees location in the orchard and fruits' position and quality data; and
c) at least one harvesting ground- or aerial-robot/unmanned aircraft vehicle (UAV), wherein said system is designed to control/manage fruits harvesting/dilution by said at least one harvesting robot/UAV during nighttime based on data in said database.

2. A system for nighttime fruit harvesting, dilution and/or pruning, the system comprising:
a) at least one ground/flying unit equipped with a camera for taking a plurality of photographs of a predetermined zone during daytime;
b) a computerized system for mapping an orchard, comprising a processor and memory for receiving said plurality of photographs, wherein said computerized system is designed to (i) visually identify one or more markers of anchor units in said photographs and their geographic location; (ii) map trees identified in said photographs in relation to the location of identified one or more anchor units; and (iii) generate a database of trees location in the orchard; and
c) at least one harvesting robot/unmanned aircraft vehicle (UAV).

3. The system of claim 2, wherein said at least one flying unit further collects fruits' data at daylight, e.g. fruit quality and position.

4. The system of claim 2, further comprising at least one data collection robot/UAV for collecting fruits' data at daylight, e.g. fruit quality and position.

5. The system of claim 2, wherein said database further comprises fruits' position and quality data.

6. The system of claim 2, which is designed to control/manage fruits harvesting/dilution by said at least one harvesting robot/UAV during nighttime based on data from said database.

7. The system of claim 2, wherein said at least one harvesting robot/UAV is a ground harvesting robot.

8. The system of claim 2, wherein said at least one harvesting robot/UAV is a harvesting UAV.

9. A method for generating a database of fruits' position and quality in an orchard by fusing GPS data with fruits' visual data (obtained e.g. by a 2D or 3D camera), obtained during daytime, wherein said database is designed to be used for instructing nighttime harvesting/dilution by a harvesting robot/UAV.

10. A management system for autonomous robot/UAV fleet management for harvesting or diluting fruits during nighttime, said system comprises:
a) one or more autonomous robots/UAVs for harvesting fruit or dilution fruit;
b) a computerized system for mapping an orchard or a database of trees' position and their contour;
c) optionally, a fruit container; and
d) one or more energy suppliers,
wherein said management system is used for: (1) managing a fleet of robots/UAVs during nighttime; and/or (2) nighttime harvesting or dilution missions based on fruit's ripeness.

11. A method for harvesting or diluting fruits in an orchard during nighttime, the method comprising the steps of:
a) generating or obtaining a map od said orchard;
b) obtaining data regarding the quality and position of the fruits within said orchard during daytime;
c) determining which fruits should be harvested/diluted according to the fruit's quality data; and
d) instructing a harvesting robot/UAV to harvest/dilute desired fruits during nighttime.

12. The method of claim 11, further comprising a step of determining/calculating the maneuvering route for said harvesting robot/UAV according to the fruit's position data.

13. A computerized method for nighttime harvesting using a robot/UAV fleet, said method comprising the steps of:
a) building a digital representation of an orchard in a database that comprises a multi-layer representation of the orchard and fruits' information, based on GPS and visual data obtained during daytime;
b) providing tasks to autonomous fruit harvesting robots/UAVs;
c) optionally, updating said database during harvesting via data obtained from different robots/UAVs in the orchard during harvest; and
d) directing said fruit harvesting robots/UAVs to fruits that need to be harvested based on the generated database.

14. The method of claim 13, further comprising a step of instructing said fruit harvesting robots/UAVs to harvest fruits of specific characteristics and/or according to desired criteria.

15. A method for harvesting or diluting fruits in an orchard during daytime, the method comprising the steps of:
a) generating or obtaining a map of said orchard;
b) obtaining data regarding the quality and position of the fruits within said orchard during nighttime, e.g. by using controlled illumination or suitable night-vision means;
c) determining which fruits should be harvested/diluted according to the fruit's quality data, and planning a harvesting plan; and
d) instructing a harvesting robot/UAV to harvest/dilute desired fruits during daytime.

16. A method for analyzing data of fruit quality in a certain time when optical data (as 2D camera) is reliable and harvesting it at a different time according to previous data or with fusion of previous data with current harvester data.
